(19) United States
(12) Patent Application Publication
(10) Pub. No.: US 2025/0267601 A1
(43) Pub. Date: Aug. 21, 2025

(54) ON-DEMAND SSB ON A SCELL

(71) Applicant: Samsung Electronics Co., Ltd., Suwon-si (KR)

(72) Inventors: Hongbo Si, Allen, TX (US); Anil Agiwal, McKinney, TX (US)

(21) Appl. No.: 19/043,360

(22) Filed: Jan. 31, 2025

Related U.S. Application Data
(60) Provisional application No. 63/553,854, filed on Feb. 15, 2024.
(60) Provisional application No. 63/568,913, filed on Mar. 22, 2024.
(60) Provisional application No. 63/640,594, filed on Apr. 30, 2024.
(60) Provisional application No. 63/645,462, filed on May 10, 2024.

(51) Int. Cl. H04W 56/00; H04W 24/10; H04W 80/02

(52) U.S. Cl. CPC H04W 56/0015; H04W 24/10; H04W 80/02

(57) ABSTRACT

Apparatuses and methods for on-demand synchronization signal block (SSB) on a secondary cell (SCell). A method of a user equipment (UE) in a wireless communication system includes receiving a set of higher layer parameters including a first set of configurations for a SCell and identifying, based on the set of higher layer parameters, a second set of configurations related to on-demand synchronization signals and physical broadcast channel (SS/PBCH) blocks on the SCell. The second set of configurations includes a first indication of whether a transmission of the on-demand SS/PBCH blocks is activated on the SCell. The method further includes, when the transmission of the on-demand SS/PBCH blocks is indicated to be activated based on the first indication, receiving the on-demand SS/PBCH blocks based on the second set of configurations.

### CROSS-REFERENCE TO RELATED AND CLAIM OF PRIORITY

The present application claims priority under 35 U.S.C. § 119 (e) to U.S. Provisional Patent Application No. 63/553,854 filed on Feb. 15, 2024; U.S. Provisional Patent Application No. 63/568,913 filed on Mar. 22, 2024; U.S. Provisional Patent Application No. 63/640,594 filed on Apr. 30, 2024; and U.S. Provisional Patent Application No. 63/645,462 filed on May 10, 2024, which are hereby incorporated by reference in their entirety.

### TECHNICAL FIELD

The present disclosure relates generally to wireless communication systems and, more specifically, the present disclosure is related to apparatuses and methods for on-demand synchronization signal block (SSB) on a secondary cell (SCell).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to on-demand SSB on a SCell.

In one embodiment, a user equipment (UE) in a wireless communication system is provided. The UE includes a transceiver configured to receive a set of higher layer parameters including a first set of configurations for a SCell and a processor operably coupled to the transceiver. The processor is configured to identify, based on the set of higher layer parameters, a second set of configurations related to on-demand synchronization signals and physical broadcast channel (SS/PBCH) blocks on the SCell. The second set of configurations includes a first indication of whether a transmission of the on-demand SS/PBCH blocks is activated on the SCell. The transceiver is further configured to, when the transmission of the on-demand SS/PBCH blocks is indicated to be activated based on the first indication, receive the on-demand SS/PBCH blocks based on the second set of configurations.

In another embodiment, a base station (BS) in a wireless communication system is provided. The BS includes a processor configured to determine a first set of configurations for a SCell and determine a second set of configurations related to on-demand SS/PBCH blocks on the SCell. The second set of configurations include a first indication of whether a transmission of the on-demand SS/PBCH blocks is activated on the SCell. The BS further includes a transceiver operably coupled to the processor. The transceiver configured to transmit a set of higher layer parameters including the first set and the second set of configurations and transmit the on-demand SS/PBCH blocks based on the second set of configurations, when the transmission of the on-demand SS/PBCH blocks is indicated to be activated based on the first indication.

In yet another embodiment, a method of a UE in a wireless communication system is provided. The method includes receiving a set of higher layer parameters including a first set of configurations for a SCell and identifying, based on the set of higher layer parameters, a second set of configurations related to on-demand SS/PBCH blocks on the Scell. The second set of configurations includes a first indication of whether a transmission of the on-demand SS/PBCH blocks is activated on the SCell. The method further includes, when the transmission of the on-demand SS/PBCH blocks is indicated to be activated based on the first indication, receiving the on-demand SS/PBCH blocks based on the second set of configurations.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates a diagram of an example SSB transmission according to embodiments of the present disclosure;

FIG. 6 illustrates a diagram of an example on-demand SSB transmission according to embodiments of the present disclosure;

FIG. 7 illustrates a flowchart of an example UE procedure using an on-demand SSB according to embodiments of the present disclosure according to embodiments of the present disclosure;

FIG. 8 illustrates a diagram of an example on-demand SSB transmission according to embodiments of the present disclosure;

FIG. 9 illustrates a flowchart of an example UE procedure for using an on-demand SSB according to embodiments of the present disclosure;

FIG. 10 illustrates a diagram of an example on-demand SSB transmission according to embodiments of the present disclosure;

FIG. 11 illustrates a flowchart of an example UE procedure for using an on-demand SSB according to embodiments of the present disclosure;

FIG. 12 illustrates a diagram of an example on-demand SSB transmission according to embodiments of the present disclosure; and

FIG. 13 illustrates a flowchart of an example UE procedure for activating/deactivating an on-demand SSB transmission according to embodiments of the present disclosure.

### DETAILED DESCRIPTION

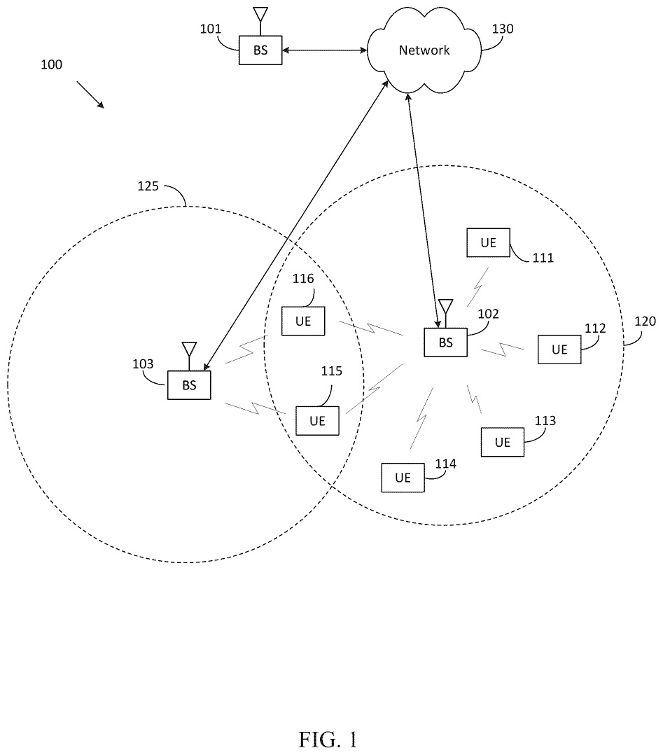

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1] 3GPP TS 38.211 v16.6.0, “NR; Physical channels and modulation;” [2] 3GPP TS 38.212 v16.6.0, “NR; Multiplexing and channel coding;” [3] 3GPP TS 38.213 v16.6.0, “NR; Physical layer procedures for control;” [4] 3GPP TS 38.214 v16.6.0, “NR; Physical layer procedures for data;” and [5] 3GPP TS 38.331 v16.5.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for on-demand SSB on SCell in a wireless communication system. In certain embodiments, and one or more of the gNBs 101-103 includes circuitry, programing, or a combination thereof, for supporting on-demand SSB on SCell in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

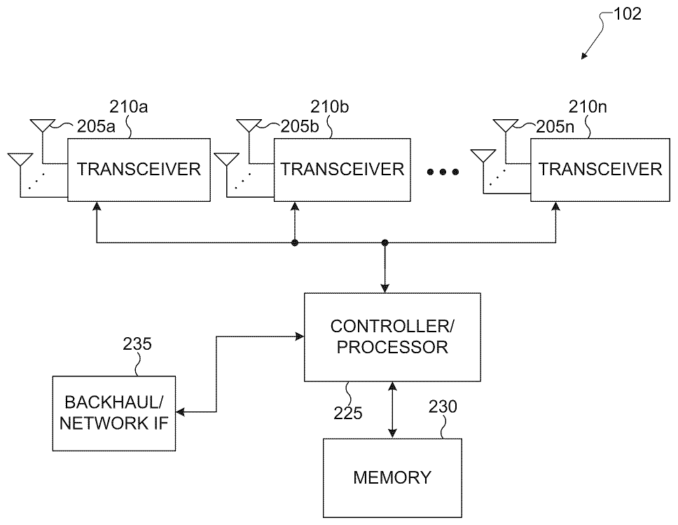

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of downlink (DL) channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting on-demand SSB on SCell in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

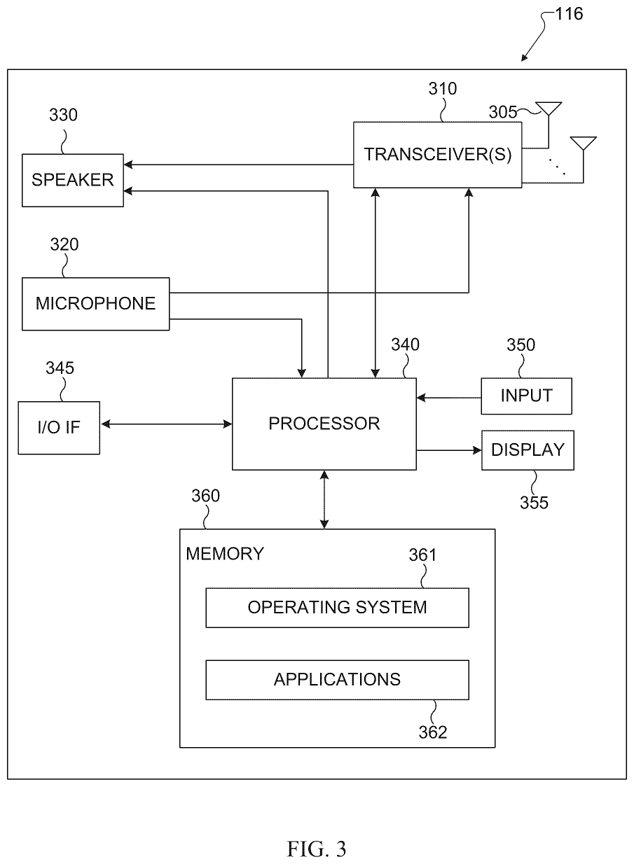

FIG. 3 illustrates an example UE according to embodiments of the present disclosure. The embodiment of the UE illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE includes antenna(s) 305, a transceiver(s) 310, and a microphone 320. The UE also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE. For example, the processor 340 could control the reception of DL channels and/or signals and the transmission of UL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for on-demand SSB on SCell in a wireless communication system.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE can use the input 350 to enter data into the UE. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE configured as a mobile telephone or smartphone, UEs could be configured to operate as other types of mobile or stationary devices.

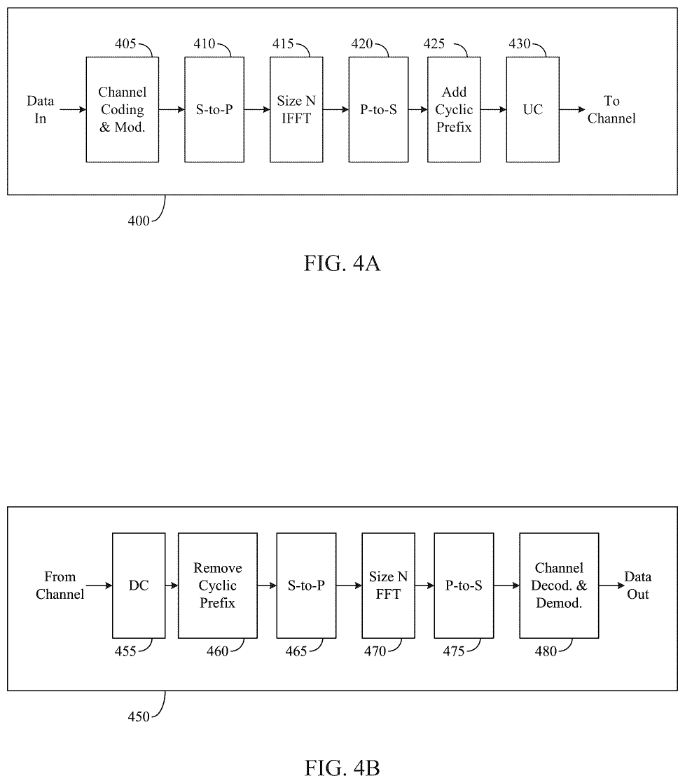

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE). However, it will be understood that the receive path 450 can be implemented in a gNB and that the transmit path 400 can be implemented in a UE. In some embodiments, the transmit path 400 and/or the receive path 450 is configured for on-demand SSB on SCell as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

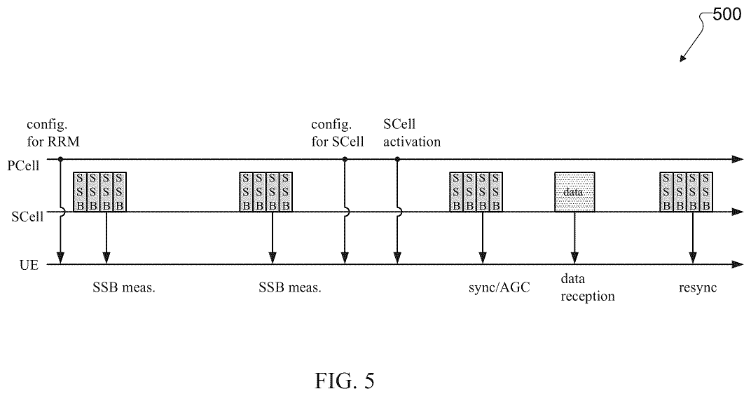

FIG. 5 illustrates a diagram of an example SSB transmission 500 according to embodiments of the present disclosure. For example, any of the UEs 111-116 of FIG. 1 can receive SSB transmission 500. This example is for illustration only and other embodiments can be used without departing from the scope of the present disclosure.

In typical NR as illustrated in FIG. 5, for a SCell implemented with periodic synchronization signal/physical broadcast channel (SS/PBCH) block transmission, a UE (e.g., the UE 116) can be provided with a configuration for measurement (e.g., radio resource management (RRM) measurement) based on the periodic SS/PBCH blocks, wherein the configuration can be provided by a RRC parameter. After the measurement, the gNB (e.g., the BS 102) can provide a configuration of the SCell, e.g., by another RRC parameter. The UE can be further provided with a medium access control (MAC) control element (CE) indicating an activation of the SCell, and by using the periodic SS/PBCH blocks on the SCell, or tracking reference signal (TRS) if configured, or the SS/PBCH blocks on the PCell when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH blocks for resynchronization. Since SS/PBCH block is transmitted on the SCell periodically, the power consumption for SS/PBCH block can be significantly large. Embodiments of the present disclosure recognize that there is a need to reduce the power consumption. On-demand SSB can be supported on the SCell.

This disclosure focuses on the support of on-demand SSB in various scenarios. More precisely, the following aspects are included in the disclosure:
On-demand SSB for measurement (e.g., RRM measurement and/or layer 1 measurement) on SCell
On-demand SSB for SCell activation
On-demand SSB for SCell after activation, e.g., for resynchronization when the SCell is activated

In one example, the on-demand SSB can be applicable to at least one of the following cases for instance:
In a first instance, there is a periodic SSB transmission on the same cell, e.g., configured by the gNB on the SCell. For this instance, there could be a further evaluation that the transmission of on-demand SSB does not impact the periodic SSB transmission, e.g., no overlapping resource in time and/or frequency domain according the configurations of the on-demand SSB and periodic SSB, and/or the transmission of on-demand SSB may not terminate or interrupt the transmission of periodic SSB which implies the on-demand SSB may not be transmitted (e.g., when there is any overlapping resource in time and/or frequency domain according the configurations of the on-demand SSB and periodic SSB). For another further evaluation, the transmission of on-demand SSB can be terminated based on gNB's indication and/or a timer/duration/counter from the start of the transmission.
In a second instance, there is a periodic SSB transmission on another cell wherein the other cell is configured or determined as the reference cell for the cell that supports on-demand SSB transmission. For this instance, there could be a further evaluation that the transmission of on-demand SSB does not impact the periodic SSB transmission, e.g., no overlapping resource in time and/or frequency domain according the configurations of the on-demand SSB and periodic SSB, and/or the transmission of on-demand SSB may not terminate or interrupt the transmission of periodic SSB which implies the on-demand SSB may not be transmitted (e.g., when there is any overlapping resource in time and/or frequency domain according the configurations of the on-demand SSB and periodic SSB). For another further evaluation, the transmission of on-demand SSB can be terminated based on gNB's indication and/or a timer/duration/counter from the start of the transmission.
In a third instance, there is no periodic SSB transmission in the same cell (e.g., configured by the gNB on the SCell) or no periodic SSB transmission on another cell wherein the other cell is configured or determined as the reference cell for the cell that supports on-demand SSB transmission. For this instance, there could be a further evaluation that the transmission of on-demand SSB may follow a periodic pattern (e.g., uniform interval), e.g., potentially with a further condition that the UE does not receive indication to deactivate the on-demand SSB transmission, or the SCell is still activated, or the SCell is still configured.
In a forth instance, there is periodic SSB transmission on another cell wherein the other cell is configured or determined as the reference cell for the cell that supports on-demand SSB transmission. For this instance, there could be a further evaluation that the transmission of on-demand SSB may follow a periodic pattern (e.g., uniform interval), e.g., potentially with a further condition that the UE does not receive indication to deactivate the on-demand SSB transmission, or the SCell is still activated, or the SCell is still configured.

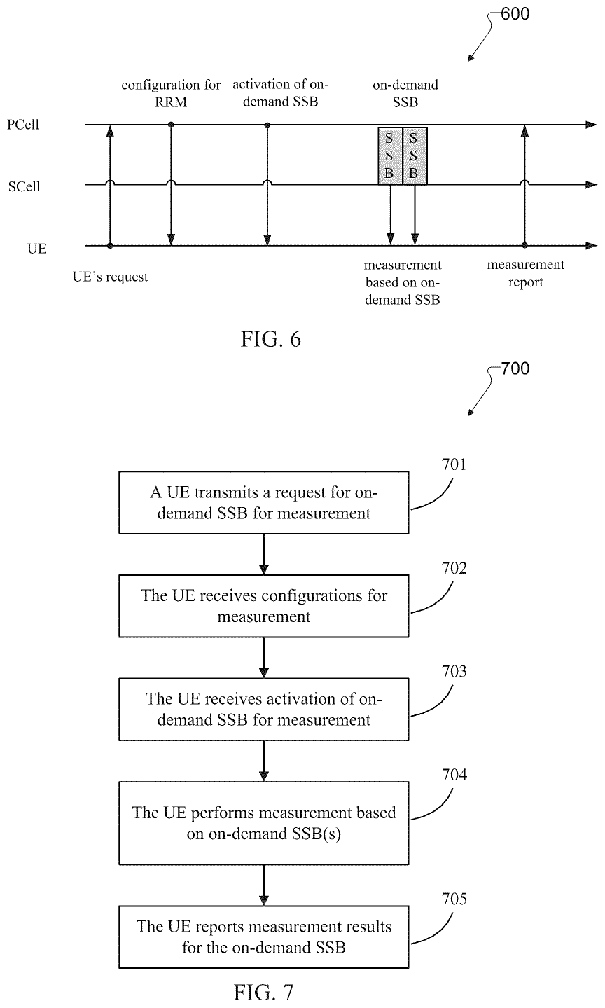

FIG. 6 illustrates a diagram of an example on-demand SSB transmission 600 according to embodiments of the present disclosure. For example, on-demand SSB transmission 600 can be received by any of the UEs 111-116 of FIG. 1, such as the UE 116. This example is for illustration only and other embodiments can be used without departing from the scope of the present disclosure.

In one embodiment, on-demand SS/PBCH block (SSB) can be used for measurement, e.g., radio resource management (RRM) measurement and/or layer 1 (L1) measurement, e.g., on a SCell.

An illustration of examples of this embodiment for measurement (e.g., RRM measurement and/or L1 measurement) based on on-demand SSB, e.g., on a SCell, is shown in FIG. 6.

In one example, the configuration for measurement based on SSB (e.g., either in system information or dedicated RRC parameter) can include an indication on whether the SSB for measurement includes or is on-demand SSB or not. For one instance, the indication can be an explicit field in the configuration for measurement based on SSB. For another instance, the indication can be based on a field or fields, in the configuration for measurement based on SSB, that provides configuration of the on-demand SSB, and the existence of the field(s) implies the associated SSB for measurement is on-demand SSB.

In another example, the configuration for measurement based on SSB (e.g., either in system information or dedicated RRC parameter) can include a configuration on on-demand SSB to be used for measurement (e.g., configuration of time, and/or frequency, and/or power, and/or spatial information of the on-demand SSB for measurement). When the UE receives the configuration, the UE expects on-demand SSB for measurement is transmitted according to the configuration, and the UE can perform measurement based on the on-demand SSB, potentially with a time domain delay.
For one instance, the time domain delay at least includes the time duration for the UE to process the decoding of the configuration (e.g., either in system information or dedicated RRC parameter).

In yet another example, the configuration for measurement based on SSB (e.g., either in system information or dedicated RRC parameter) can include a configuration on the measurement report for the measurement based on the on-demand SSB(s) (e.g., configuration of time, and/or frequency, and/or power, and/or spatial information of the measurement report). When the UE receives the configuration, the UE reports the measurement results according to the configured occasions, potentially with a time domain delay.
For one instance, the time domain delay at least includes the time duration for the UE to process the decoding of the configuration (e.g., either in system information or dedicated RRC parameter).

In yet another example, the configuration for measurement based on SSB (e.g., either in system information or dedicated RRC parameter) can include a configuration on on-demand SSB to be used for measurement (e.g., configuration of time, and/or frequency, and/or power, and/or spatial information of the on-demand SSB for RRM measurement). The UE can be further provided with an indication on activation and/or deactivation of the on-demand SSB, and the UE can expect the transmission of on-demand SSB from the gNB on the SCell, and/or perform measurement based on the on-demand SSB after receiving the indication that indicates the activation of the on-demand SSB, potentially with a time domain delay.
For one instance, the configuration for a SCell can include multiple sets of configurations (e.g., time, and/or frequency, and/or power, and/or spatial configurations) for the on-demand SSB, and the activation of the on-demand SSBs includes an indication of which set of configurations to be utilized for actual transmission.
For another instance, the indication for activation and/or deactivation of the on-demand SSB can be included in a MAC CE, e.g., the MAC CE can be an enhanced MAC CE for activation and/or deactivation of the SCell, which includes the functionality of indicating activation and/or deactivation of on-demand SSB, or the MAC CE can be a further enhanced MAC CE for activation and/or deactivation of the SCell and TRS transmission, which further includes the functionality of indicating activation and/or deactivation of on-demand SSB, or a new MAC CE which includes the functionality of indicating activation and/or deactivation of on-demand SSB.
For yet another instance, the indication for activation and/or deactivation of the on-demand SSB can be included in a downlink control information (DCI) format carried by a physical downlink control channel (PDCCH).
For yet another instance, the indication for activation and/or deactivation of the on-demand SSB can be included in RRC parameter (e.g., SCell configuration as described in the disclosure).
For yet another instance, the time domain delay at least includes the time duration for the UE to process the activation of the on-demand SSB, e.g., a hybrid automatic repeat request (HARQ) feedback time (the timing between DL data transmission and acknowledgement) when the activation is based on MAC CE, or a PDCCH decoding time when the activation is based on a DCI format.

In yet another example, the configuration for measurement based on SSB (e.g., either in system information or dedicated RRC parameter) can include a configuration on candidate occasions for the on-demand SSBs to be used for measurement (e.g., configuration of time, and/or frequency, and/or power, and/or spatial information of the candidate occasions). The UE can be further provided with an indication on the activation and/or deactivation of the actually transmitted on-demand SSBs, wherein the actually transmitted on-demand SSBs are selected from the candidate occasions for the on-demand SSBs, and the UE can expect the transmission of on-demand SSB from the gNB on the SCell, and/or perform measurement based on the actually transmitted on-demand SSB after receiving the indication that indicates activation of the actually transmitted on-demand SSB, potentially with a time domain delay. The indication can be explicit, e.g., an explicit field in the indication, or be implicit, e.g., based on the time domain location of the indication.
For one instance, the configuration for a SCell can include multiple sets of configurations (e.g., time, and/or frequency, and/or power, and/or spatial configurations) for the on-demand SSB, and the activation of the actually transmitted on-demand SSBs includes an indication of which set of configurations to be utilized for actual transmission.
For another instance, the indication for activation and/or deactivation of the actually transmitted on-demand SSB can be included in a MAC CE, e.g., the MAC CE can be an enhanced MAC CE for activation of the SCell, which includes the functionality of activation of actually transmitted on-demand SSB, or the MAC CE can be a further enhanced MAC CE for activation of the SCell and TRS transmission, which further includes the functionality of activation of actually transmitted on-demand SSB, or a new MAC CE which includes the functionality of activation of actually transmitted on-demand SSB.
For yet another instance, the indication for activation and/or deactivation of the actually transmitted on-demand SSB can be included in a DCI format carried by a PDCCH.
For yet another instance, the indication for activation and/or deactivation of the on-demand SSB can be included in RRC parameter (e.g., SCell configuration as described in the disclosure).

In yet another example, a UE can send at least one request to the gNB on a configuration or a set of configurations of the on-demand SSB to be used for measurement, e.g., before or after receiving a configuration for measurement based on SSB.
For one instance, the at least one request can be included in a physical random access channel (PRACH).
For another instance, the at least one request can be included in a physical uplink control channel (PUCCH).
For yet another instance, the at least one request can be included in a physical uplink shared channel (PUSCH).
For yet another instance, the at least one request can be included in a scheduling request (SR).
For yet another instance, the at least one request can be included in uplink control information (UCI).
For yet another instance, the configuration or the set of configurations of the on-demand SSB can be based on at least one SSB index (e.g., at least one SSB index that the UE is requesting for transmission from the gNB, or at least one SSB index that the UE is reporting to have link connection issue such as beam failure, bad measurement result, or data reception failure using the corresponding SSB as the source RS of quasi co-location (QCL) assumption or transmission configuration indication (TCI) state).
For yet another instance, when the configuration or the set of configurations of the on-demand SSB does not include information for the at least one SSB index, the gNB can expect the UE is requesting for all candidate SSB indexes (e.g., from the maximum number of SSB indexes).
For yet another instance, when the configuration or the set of configurations of the on-demand SSB does not include information for the at least one SSB index, the gNB can expect the UE is requesting for all actually transmitted SSB indexes (e.g., from the indexes corresponding to the actually transmitted SSBs indicated by system information block 1 (SIB1) or dedicated RRC parameter).
For yet another instance, the configuration or the set of configurations of the on-demand SSB can include a number of SSB bursts, e.g., a number of repeated SSB burst transmissions.
For yet another instance, the configuration or the set of configurations of the on-demand SSB can include an interval between two consecutive SSB bursts, e.g., a number of half frames between the half frames that includes the two consecutive SSB bursts' transmissions.
For yet another instance, the configuration or the set of configurations of the on-demand SSB can include a delay for the on-demand SSB transmission, e.g., with respect to the uplink trigger, or with respect to the downlink trigger of the on-demand SSB.
For yet another instance, the at least one request can be transmitted on the PCell.
For yet another instance, the at least one request can be transmitted on a SCell different from the SCell that includes the intended on-demand SSB transmission, e.g., an activated SCell.
For yet another instance, the at least one request can include multiple requests, e.g., a first request according to a first example of this disclosure, and a second request according to a second example of this disclosure, with potentially gNB's transmission between the two requests (e.g., an uplink grant).

In yet another example, the UE can send a report of measurement result for the on-demand SSB based measurement to the gNB.
For one instance, the report can be transmitted after performing measurement based on the on-demand SSB(s) configured for measurement (e.g., the on-demand SSB(s) by the same UE request, or the on-demand SSB(s) by the activation of on-demand SSB).
For another instance, the report can be transmitted in multiple occasions, wherein the report in each occasion corresponds to the measurement results based on part of the on-demand SSB(s) configured for measurement (e.g., the UE determines a number of on-demand SSB(s) within a pre-defined or configured measurement duration).
For yet another instance, the report can be included in a UCI.
For yet another instance, the report can be carried by a PUCCH.
For yet another instance, the report can be carried by a PUSCH. For one sub-instance, the report can be included in an uplink MAC CE.
For yet another instance, the report can be sent in an aperiodic manner.
For yet another instance, the report can be sent in a periodic or semi-persistent manner, e.g., multiple occasions with an interval.

FIG. 7 illustrates a flowchart of an example UE procedure 700 according to embodiments of the present disclosure. For example, procedure 700 can be performed by the UE 116 of FIG. 3. This example is for illustration only and other embodiments can be used without departing from the scope of the present disclosure.

An example UE procedure for using on-demand SSB for measurement, e.g., on a SCell, is shown in FIG. 7.
For one instance, operation 701 can be absent in some example UE procedures for using on-demand SSB for measurement, e.g., the on-demand SSB may not be requested by a UE.
For another instance, operation 703 can be absent or merged with operation 702 in some example UE procedures for using on-demand SSB for measurement, e.g., the on-demand is activated after it is configured with measurement.
For yet another instance, operation 705 can be absent in some example UE procedures for using on-demand SSB for measurement, e.g., the reporting of measurement result based on on-demand SSB can be combined with the reporting of measurement result based on periodical SSB on the SCell.
For yet another instance, the order of operation 701 and operation 702 can be swapped in some example UE procedures for using on-demand SSB for measurement, e.g., at least one of the condition(s) for sending a UE request for on-demand SSB on a SCell (e.g., for measurement) is that the UE request can take place after receiving the configuration for measurement.
For yet another instance, there could be a starting instance requirement on the on-demand SSB in operation 704, e.g., after receiving the measurement configuration.
For yet another instance, there could be a starting instance requirement on the on-demand SSB in operation 704, e.g., after the SCell is configured.
For yet another instance, there could be a starting instance requirement on the on-demand SSB in operation 704, e.g., after receiving the SCell activation command.
For yet another instance, there could be an ending instance requirement on the on-demand SSB in operation 704, e.g., before the end of the delay for SCell activation and the on-demand SSB may not be needed after the SCell is activated.
For yet another instance, there could be an ending instance requirement on the on-demand SSB in operation 704, e.g., before receiving the SCell activation command.

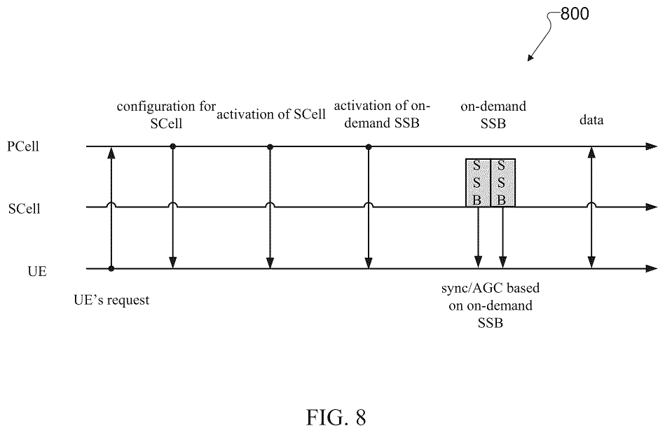

FIG. 8 illustrates a diagram of an example on-demand SSB transmission 800 according to embodiments of the present disclosure. For example, on-demand SSB transmission 800 can be received by the UE 111 of FIG. 1. This example is for illustration only and other embodiments can be used without departing from the scope of the present disclosure.

In one embodiment, on-demand SS/PBCH block (SSB) can be used at least for activation of a SCell (e.g., facilitating fast SCell activation including at least one of synchronization, or automatic gain control (AGC)).
For one further evaluation, the on-demand SSB used at least for activation of a SCell can also be used for RRM measurement, and examples in other embodiments of this disclosure for RRM measurement can also be applicable for this embodiment.
For one further evaluation, the on-demand SSB used at least for activation of a SCell can also be used for synchronization and/or re-synchronization and/or L1 measurement and/or beam management, and examples in other embodiments of this disclosure for synchronization and/or re-synchronization and/or L1 measurement and/or beam management can also be applicable for this embodiment.

An illustration of examples of this embodiment at least for activation of a SCell based on on-demand SSB is shown in FIG. 8.

In one example, the configuration(s) for a SCell (e.g., in a dedicated RRC parameter) can include an indication on whether the SCell supports or is implemented with on-demand SSB or not. For one instance, the indication can be an explicit field in the configuration for a SCell. For another instance, the indication can be based on a field or fields, in the configuration for a SCell, that provides configurations of the on-demand SSB, and the existence of the field(s) implies the SCell supports or is implemented with on-demand SSB.

In another example, the configuration(s) for a SCell (e.g., in a dedicated RRC parameter) can include a configuration or configurations of on-demand SSB to be transmitted on the SCell (e.g., configuration(s) of time, and/or frequency, and/or power, and/or spatial information of the on-demand SSB). When the UE receives the configuration(s), the UE expects on-demand SSB is transmitted according to the configuration(s) on the SCell, and the UE can perform AGC and/or synchronization and/or RRM measurement and/or L1 measurement based on the on-demand SSB, e.g., in order to activate the SCell, potentially with a time domain delay.
For one instance, the time domain delay at least includes the time duration for the UE to process the decoding of the configuration (e.g., in dedicated RRC parameter).
For another instance, this example can be applicable with a further condition that the configuration for the SCell includes an indication on activation of the SCell.

In yet another example, the configuration(s) for a SCell (e.g., in a dedicated RRC parameter) can include a configuration or configurations of on-demand SSB to be transmitted on the SCell (e.g., configuration(s) of time, and/or frequency, and/or power, and/or spatial information of the on-demand SSB) and/or an indication on activation and/or deactivation of the on-demand SSB transmission. When the UE receives the configuration(s) and determines the indication in the configuration(s) indicates the on-demand SSB is activated, the UE expects on-demand SSB is transmitted according to the configuration(s) on the SCell, and the UE can perform AGC and/or synchronization and/or RRM measurement and/or L1 measurement based on the on-demand SSB, e.g., in order to activate the SCell, potentially with a time domain delay.
For one instance, the time domain delay at least includes the time duration for the UE to process the decoding of the configuration(s) (e.g., in the dedicated RRC parameter).
For another instance, this example can be applicable with a further condition that the configuration(s) for the SCell includes an indication on activation of the SCell.

In yet another example, the configuration(s) for a SCell (e.g., in a dedicated RRC parameter) can include a configuration or configurations on on-demand SSB to be transmitted on the SCell (e.g., configuration(s) of time, and/or frequency, and/or power, and/or spatial information of the on-demand SSB). The UE can be further provided with an indication for activation and/or deactivation of the on-demand SSB, and the UE can expect the transmission of on-demand SSB from the gNB on the SCell, and/or perform SCell activation based on the on-demand SSB after receiving the indication that indicates activation of the on-demand SSB, potentially with a time domain delay.
For one instance, the configuration(s) for the SCell can include multiple sets of configurations (e.g., time, and/or frequency, and/or power, and/or spatial configurations) for the on-demand SSB, and the indication that indicates the activation of the on-demand SSBs includes an indication of which set of configurations to be utilized for actual transmission.
For another instance, the indication for activation and/or deactivation of the on-demand SSB can be included in a MAC CE. For one sub-instance, the MAC CE can also include an indication on the activation and/or deactivation of the SCell, e.g., the MAC CE can be an enhanced MAC CE for activation and/or deactivation of the SCell, which includes the functionality of indicating activation and/or deactivation of on-demand SSB, or the MAC CE can be a further enhanced MAC CE for activation and/or deactivation of the SCell and TRS transmission, which further includes the functionality of indicating activation and/or deactivation of on-demand SSB, or a new MAC CE which includes the functionality of indicating activation and/or deactivation of on-demand SSB.
For yet another instance, the indication for activation and/or deactivation of the on-demand SSB can be included in a DCI format carried by a PDCCH.
For yet another instance, the indication for activation and/or deactivation of the on-demand SSB can be included in RRC parameter (e.g., SCell configuration(s) as described in the disclosure). For one further evaluation, this instance can be applicable when the SCell configuration(s) includes the field indicating SCell is activated.
For yet another instance, when the SCell configuration(s) includes the field indicating SCell is activated, the indication for activation and/or deactivation of the on-demand SSB can be located in the same slot or symbol(s) as the SCell configuration(s).
For yet another instance, the time domain delay at least includes the time duration for the UE to process the activation of the on-demand SSB, e.g., a HARQ feedback time (the timing between DL data transmission and acknowledgement) when the indication of activation and/or deactivation is based on MAC CE, or a PDCCH decoding time when the indication of activation and/or deactivation is based on a DCI format in a PDCCH.

In yet another example, the configuration(s) for a SCell (e.g., in a dedicated RRC parameter) can include a configuration or configurations on candidate occasions for the on-demand SSBs to be transmitted on the SCell (e.g., configuration(s) of time, and/or frequency, and/or power, and/or spatial information of the candidate occasions). The UE can be further provided with an indication for activation and/or deactivation of the actually transmitted on-demand SSBs, wherein the actually transmitted on-demand SSBs are selected from the candidate occasions for the on-demand SSBs, and the UE can expect the transmission of on-demand SSB from the gNB on the SCell, and/or perform AGC and/or synchronization and/or RRM measurement and/or L1 measurement based on the actually transmitted on-demand SSB after receiving the indication that indicates activation of the actually transmitted on-demand SSB, potentially with a time domain delay. The indication can be explicit, e.g., an explicit field in the indication, or be implicit, e.g., based on the time domain location of the indication.
For one instance, the configuration(s) for the SCell can include multiple sets of configurations (e.g., time, and/or frequency, and/or power, and/or spatial configurations) for the on-demand SSB, and the indication that indicates the activation of the actually transmitted on-demand SSBs includes an indication of which set of configurations to be utilized for actual transmission.
For another instance, the indication for activation and/or deactivation of the actually transmitted on-demand SSB can be included in a MAC CE. For one sub-instance, the MAC CE can also include an indication on the activation and/or deactivation of the SCell, e.g., the MAC CE can be an enhanced MAC CE for activation and/or deactivation of the SCell, which includes the functionality of indicating activation and/or deactivation of actually transmitted on-demand SSB, or the MAC CE can be a further enhanced MAC CE for activation and/or deactivation of the SCell and TRS transmission, which further includes the functionality of indicating activation and/or deactivation of actually transmitted on-demand SSB, or a new MAC CE which includes the functionality of indicating activation and/or deactivation of actually transmitted on-demand SSB.
For yet another instance, the indication for activation and/or deactivation of the actually transmitted on-demand SSB can be included in a DCI format carried by a PDCCH.
For yet another instance, the indication for activation and/or deactivation of the on-demand SSB can be included in RRC parameter (e.g., SCell configuration(s) as described in the disclosure). For one further evaluation, this instance can be applicable when the SCell configuration includes the field indicating SCell is activated.
For yet another instance, when the SCell configuration(s) includes the field indicating SCell is activated, the indication for activation and/or deactivation of the on-demand SSB can be located in the same slot or symbol(s) as the SCell configuration(s).
For yet another instance, the time domain delay at least includes the time duration for the UE to process the activation of the on-demand SSB, e.g., a HARQ feedback time (the timing between DL data transmission and acknowledgement) when the indication of activation and/or deactivation is based on MAC CE, or a PDCCH decoding time when the indication of activation and/or deactivation is based on a DCI format in a PDCCH.

In yet another example, a UE (e.g., the UE 116) can send at least one request to the gNB (e.g., the BS 102) on a configuration or a set of configurations of the on-demand SSB to be transmitted on the SCell, e.g., before or after receiving a configuration for the SCell, and/or before or after receiving the activation command for the SCell, and/or before or after the SCell is activated (wherein the details of the configuration or set of configurations of the on-demand SSB can refer to other example of this disclosure).
For one instance, the at least one request can be included in a PRACH.
For another instance, the at least one request can be included in a PUCCH.
For yet another instance, the at least one request can be included in a PUSCH. For one sub-instance, the at least one request can be included in an uplink MAC CE.
For yet another instance, the at least one request can be included in a SR.
For yet another instance, the at least one request can be included in UCI.
For yet another instance, the configuration or set of configurations of the on-demand SSB can be based on at least one SSB index (e.g., at least one SSB index that the UE is requesting for transmission from the gNB, or at least one SSB index that the UE is reporting to have link connection issue such as beam failure, bad measurement result, or data reception failure using the corresponding SSB as the source RS of QCL assumption or TCI state).
For yet another instance, when the configuration or set of configurations of the on-demand SSB does not include information for the at least one SSB index, the gNB can expect the UE is requesting for all candidate SSB indexes (e.g., from the maximum number of SSB indexes).
For yet another instance, when the configuration or set of configurations of the on-demand SSB does not include information for the at least one SSB index, the gNB can expect the UE is requesting for all actually transmitted SSB indexes (e.g., from the indexes corresponding to the actually transmitted SSBs indicated by SIB1 or dedicated RRC parameter).
For yet another instance, the configuration or set of configurations of the on-demand SSB can include a number of SSB bursts, e.g., a number of repeated SSB burst transmissions.
For yet another instance, the configuration or set of configurations of the on-demand SSB can include an interval between two consecutive SSB bursts, e.g., a number of half frames between the half frames that includes the two consecutive SSB bursts' transmissions.
For yet another instance, the configuration or set of configurations of the on-demand SSB can include a delay for the on-demand SSB transmission, e.g., with respect to the uplink trigger, or with respect to the downlink trigger of the on-demand SSB.
For yet another instance, the at least one request can be transmitted on the PCell.
For yet another instance, the at least one request can be transmitted on a SCell different from the SCell that includes the intended on-demand SSB transmission, e.g., an activated SCell.
For yet another instance, the at least one request can include multiple requests, e.g., a first request according to a first example of this disclosure, and a second request according to a second example of this disclosure, with potentially gNB's transmission between the two requests (e.g., an uplink grant).

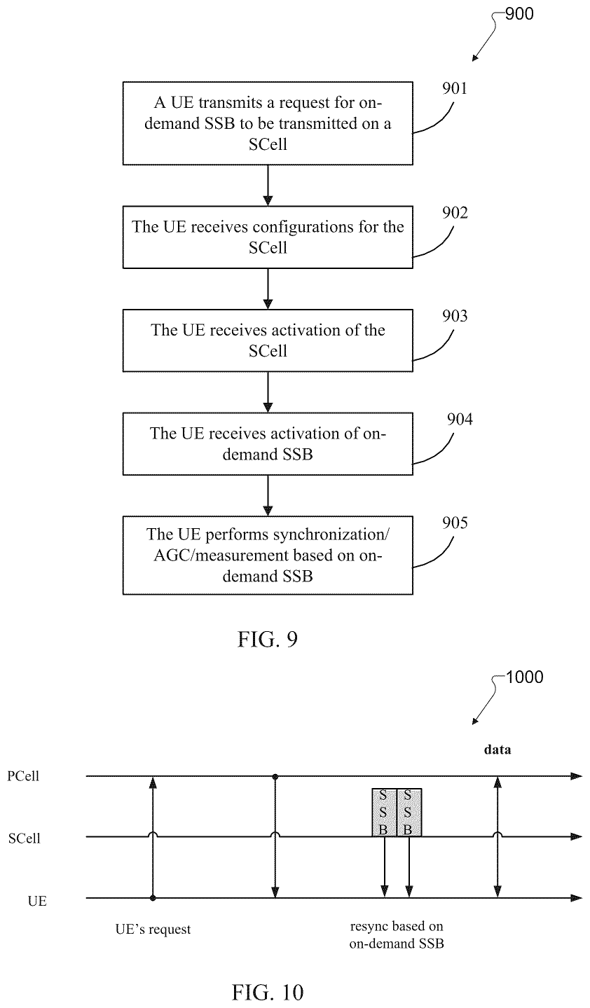

FIG. 9 illustrates a flowchart of an example UE procedure 900 for using an on-demand SSB according to embodiments of the present disclosure. For example, procedure 900 can be performed by the UE 112 of FIG. 1. This example is for illustration only and other embodiments can be used without departing from the scope of the present disclosure.

An example UE procedure for using on-demand SSB on a SCell, e.g., at least for SCell activation is shown in FIG. 9.
For one instance, operation 901 can be absent in some example UE procedures for using on-demand SSB at least for SCell activation, e.g., the on-demand SSB may not be requested by a UE.
For another instance, operation 904 can be optional, and either one or multiple of operation 901 and operation 904 can be absent in some example UE procedures for using on-demand SSB at least for SCell activation.
For yet another instance, operation 901 can be located after operation 902 in some example UE procedures for using on-demand SSB at least for SCell activation, e.g., at least one of the condition(s) for sending a UE request for on-demand SSB on a SCell is the UE request can take place after receiving the configuration of the SCell.
For yet another instance, operation 901 can be located after operation 903 in some example UE procedures for using on-demand SSB at least for SCell activation, e.g., at least one of the condition(s) for sending a UE request for on-demand SSB on a SCell is that the UE request can take place after receiving the activation command of the SCell.
For yet another instance, operation 903 and operation 904 can be merged into one operation in some example UE procedures for using on-demand SSB for SCell activation, e.g., the activation of the SCell and the indication on activation of on-demand SSB on the SCell are using the same signaling, or the activation of the SCell and the indication on activation of on-demand SSB on the SCell occur at the same time instance (e.g., same slot or same OFDM symbol(s)).
For yet another instance, the order of operation 903 and operation 904 can be swapped in some example UE procedures for using on-demand SSB at least for SCell activation, e.g., at least one of the condition(s) for indicating the activation of on-demand SSB transmission is that on-demand SSB transmission can be indicated to be activated on the SCell before the UE receives the indication on activation of the SCell (e.g., the slot/symbol including the indication on activation of on-demand SSB transmission can be before the slot/symbol including the indication on activation of the SCell). For one further evaluation of the instance, operation 902 and operation 904 can be merged into one operation in some example UE procedures for using on-demand SSB for SCell activation, e.g., the configurations of the SCell and the indication on activation of on-demand SSB on the SCell are using the same signaling, or the configurations of the SCell and the indication on activation of on-demand SSB on the SCell occur at the same time instance (e.g., same slot or same OFDM symbol(s)).
For yet another instance, there could be an ending instance requirement on the on-demand SSB in operation 905, e.g., the on-demand SSB is confined within the delay for SCell activation and the on-demand SSB may not be needed after the SCell is activated.

FIG. 10 illustrates a diagram of an example on-demand SSB transmission 1000 according to embodiments of the present disclosure. For example, on-demand SSB 1000 can be utilized by the UE 113 of FIG. 1. This example is for illustration only and other embodiments can be used without departing from the scope of the present disclosure.

In one embodiment, on-demand SS/PBCH block (SSB) can be used after a SCell is activated (e.g., for an activated SCell), e.g., for re-synchronization of a SCell, and/or L1 measurement, and/or L3 measurement (RRM measurement), and/or fast beam management on the SCell.

An illustration of examples of this embodiment for using on-demand SSB on a SCell after the SCell is activated is shown in FIG. 10.

In one example, for an activated SCell, a UE can be provided with an indication on activation and/or deactivation of the on-demand SSB, and the UE can expect the transmission of on-demand SSB from the gNB on the SCell, and/or perform SCell re-synchronization and/or beam management and/or L1 measurement, and/or L3 measurement (RRM measurement) based on the on-demand SSB after receiving the indication that indicates the activation of the on-demand SSB, potentially with a time domain delay.
For one instance, the configuration for a SCell can include multiple sets of configurations (e.g., time, and/or frequency, and/or power, and/or spatial configurations) for the on-demand SSB, and the indication of the activation and/or deactivation of the on-demand SSBs includes an indication of which set of configurations to be utilized for actual transmission.
For another instance, the indication on activation and/or deactivation of the on-demand SSB can be included in a MAC CE. For one sub-instance, the MAC CE can also include the activation of the SCell. For another sub-instance, the MAC CE can be a new MAC CE which includes the functionality of activation of on-demand SSB.
For yet another instance, the indication on activation and/or deactivation of the on-demand SSB can be included in a DCI format carried by a PDCCH.
For yet another instance, the indication on activation and/or deactivation of the on-demand SSB can be included in RRC parameter (e.g., SCell configuration(s) as described in the disclosure).
For yet another instance, the time domain delay at least includes the time duration for the UE to process the activation of the on-demand SSB, e.g., a HARQ feedback time (the timing between DL data transmission and acknowledgement) when the activation is based on MAC CE, or a PDCCH decoding time when the activation is based on a DCI format.

In another example, for an activated SCell, a UE can be provided with an indication on activation and/or deactivation of the actually transmitted on-demand SSBs, wherein the actually transmitted on-demand SSBs are selected from the candidate occasions for the on-demand SSBs, and the UE can expect the transmission of on-demand SSB from the gNB on the SCell, and/or perform re-synchronization and/or beam management and/or L1 measurement, and/or L3 measurement (RRM measurement) based on the actually transmitted on-demand SSB after receiving the indication which indicates the activation of the actually transmitted on-demand SSB, potentially with a time domain delay. The indication can be explicit, e.g., an explicit field in the indication, or be implicit, e.g., based on the time domain location of the indication.
For one instance, the configuration for a SCell can include multiple sets of configurations (e.g., time, and/or frequency, and/or power, and/or spatial configurations) for the on-demand SSB, and the activation of the actually transmitted on-demand SSBs includes an indication of which set of configurations to be utilized for actual transmission.
For another instance, the indication on activation and/or deactivation of the actually transmitted on-demand SSB can be included in a MAC CE. For one sub-instance, the MAC CE can also include the indication on activation and/or deactivation of the SCell. For another sub-instance, the MAC CE can be a new MAC CE which includes the functionality of indicating the activation and/or deactivation of actually transmitted on-demand SSB.
For yet another instance, the indication on activation and/or deactivation of the actually transmitted on-demand SSB can be included in a DCI format carried by a PDCCH.
For yet another instance, the indication on activation and/or deactivation of the on-demand SSB can be included in RRC parameter (e.g., SCell configuration(s) as described in the disclosure). For yet another instance, the time domain delay at least includes the time duration for the UE to process the activation of the on-demand SSB, e.g., a HARQ feedback time (the timing between DL data transmission and acknowledgement) when the activation is based on MAC CE, or a PDCCH decoding time when the activation is based on a DCI format.

In yet another example, a UE can send at least one request to the gNB on a configuration or a set of configurations of the on-demand SSB to be transmitted on the SCell (the details of the configuration or the set of configurations of the on-demand SSB can refer to other example of this disclosure), wherein for example, the SCell is activated.
For one instance, the at least one request can be included in a PRACH.
For another instance, the at least one request can be included in a PUCCH.
For yet another instance, the at least one request can be included in a PUSCH. For one sub-instance, the at least one request can be included in an uplink MAC CE.
For yet another instance, the at least one request can be included in a SR.
For yet another instance, the at least one request can be included in UCI.
For yet another instance, the configuration or the set of configurations of the on-demand SSB can be based on at least one SSB index (e.g., at least one SSB index that the UE is requesting for transmission from the gNB, or at least one SSB index that the UE is reporting to have link connection issue such as beam failure, bad measurement result, or data reception failure using the corresponding SSB as the source RS of QCL assumption or TCI state).
For yet another instance, when the configuration or the set of configurations of the on-demand SSB does not include information for the at least one SSB index, the gNB can expect the UE is requesting for all candidate SSB indexes (e.g., from the maximum number of SSB indexes).
For yet another instance, when the configuration or the set of configurations of the on-demand SSB does not include information for the at least one SSB index, the gNB can expect the UE is requesting for all actually transmitted SSB indexes (e.g., from the indexes corresponding to the actually transmitted SSBs indicated by SIB1 or dedicated RRC parameter).
For yet another instance, the configuration or the set of configurations of the on-demand SSB can include a number of SSB bursts, e.g., a number of repeated SSB burst transmissions.
For yet another instance, the configuration or the set of configurations of the on-demand SSB can include an interval between two consecutive SSB bursts, e.g., a number of half frames between the half frames that includes the two consecutive SSB bursts' transmissions.
For yet another instance, the configuration or the set of configurations of the on-demand SSB can include a delay for the on-demand SSB transmission, e.g., with respect to the uplink trigger, or with respect to the downlink trigger of the on-demand SSB.
For yet another instance, the at least one request can be transmitted on the PCell.
For yet another instance, the at least one request can be transmitted on a SCell different from the SCell that includes the intended on-demand SSB transmission, e.g., an activated SCell.
For yet another instance, the at least one request can include multiple requests, e.g., a first request according to a first example of this disclosure, and a second request according to a second example of this disclosure, with potentially gNB's transmission between the two requests (e.g., an uplink grant).

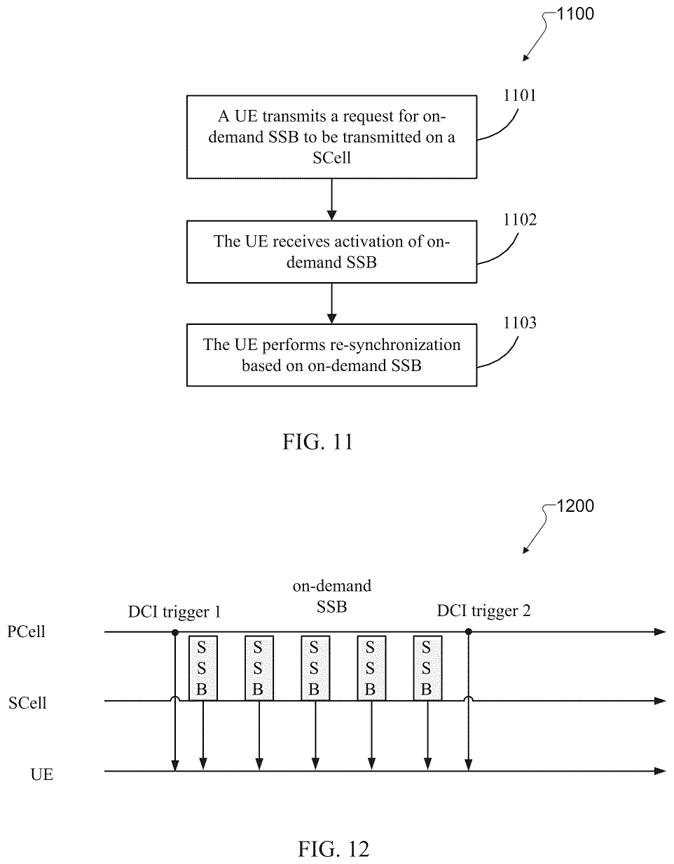

FIG. 11 illustrates a flowchart of an example UE procedure 1100 for using an on-demand SSB according to embodiments of the present disclosure. For example, procedure 1100 can be performed by any of the UEs 111-116 of FIG. 1, such as the UE 114. This example is for illustration only and other embodiments can be used without departing from the scope of the present disclosure.

An example UE procedure for using on-demand SSB after activation of the SCell (e.g., for an active SCell), e.g., for SCell re-synchronization and/or fast beam management on the SCell is shown in FIG. 11.
For one instance, operation 1101 can be absent in some example UE procedures for using on-demand SSB for SCell activation, e.g., the on-demand SSB may not be requested by a UE.
For another instance, operation 1102 can be optional, and either one or multiple of operation 1101 and operation 1102 can be absent in some example UE procedures for using on-demand SSB after activation of the SCell, e.g., for SCell re-synchronization, and/or fast beam management on the SCell.
For yet another instance, there could be a starting instant requirement on the request for the on-demand SSB in operation 1101, e.g., after the SCell is activated (e.g., receiving the SCell activation command and after the delay for SCell activation), or after receiving the SCell activation command.
For yet another instance, there could be a starting instant requirement on the activation of on-demand SSB in operation 1102, e.g., after the SCell is activated (e.g., receiving the SCell activation command and after the delay for SCell activation), or after receiving the SCell activation command.
For yet another instance, there could be a starting instant requirement on the on-demand SSB in operation 1103, e.g., after the SCell is activated (e.g., receiving the SCell activation command and after the delay for SCell activation), or after receiving the SCell activation command.

FIG. 12 illustrates a diagram of an example on-demand SSB transmission 1200 according to embodiments of the present disclosure. For example, on-demand SSB transmission 1200 can be received by any of the UEs 111-116 of FIG. 1, such as the UE 115. This example is for illustration only and other embodiments can be used without departing from the scope of the present disclosure.

For example, on-demand SSB(s) can be indicated to be transmitted or activated by a first indication (e.g., a first DCI format) from the gNB (e.g., the BS 102) and/or triggered to be terminated by a second indication (e.g., a second DCI format) from the gNB, wherein for instance, the first DCI format and the second DCI format can be the same format and with different information bits (e.g., content of the DCI format), or the first DCI format the second DCI format can be two different DCI formats. An illustration of the on-demand SSB triggered by DCI format(s) is shown in FIG. 12.

This disclosure includes the design details on the DCI format activating and/or deactivating the transmission of on-demand SSB.

This disclosure focuses on a DCI format for activating and/or deactivating on-demand SSB transmission. More precisely, the following aspects are included in the disclosure:
Configuration of the DCI format
· Components included in the DCI format
· Relationship to other DCI format
· Example UE procedure for activating and deactivating on-demand SSB transmission using DCI format(s)

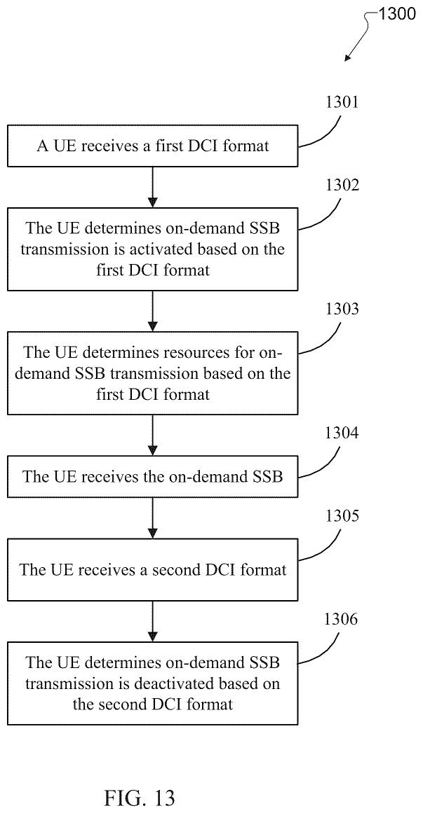

FIG. 13 illustrates a flowchart of an example UE procedure 1300 for activating and/or deactivating an on-demand SSB transmission according to embodiments of the present disclosure. For example, procedure 1300 can be performed by any of the UEs 111-116 of FIG. 1, such as the UE 115. This example is for illustration only and other embodiments can be used without departing from the scope of the present disclosure.

In one embodiment, a set of configurations for a DCI format can be provided to the UE, e.g., by higher layer parameters.
For one example, the set of configurations for the DCI format can include a size of the DCI format.
For one further evaluation, there can be a maximum value on the number of bits for the configurable size of the DCI format, such as 128 bits, or 126 bits.
For another further evaluation, the size of the DCI format can be upper bounded by another DCI format.
For yet another further evaluation, if the number of information bits corresponding to the components included of the DCI format (e.g., as described in this disclosure) is smaller than the size of the DCI format (e.g., provided by a higher layer parameter), the remaining bits other than the information bits in the DCI format are reserved, or padded as 0, or ignored by the UE.

For another example, the set of configurations for the DCI format can include a radio network temporary identifier (RNTI) for the DCI format.
For one sub-example, the RNTI can be power saving radio network temporary identifier (PS-RNTI), which corresponds to the use case of PDCCH reception in the discontinuous reception (DRX) mode operation.
For another sub-example, the RNTI can be slot format indication RNTI (SFI-RNTI), which corresponds to the use case of slot format notification.
For yet another sub-example, the RNTI can be cellDTRX-RNTI, which corresponds to the use case of activating or de-activating the cell discontinuous transmission (DTX) and/or DRX configuration.
For yet another sub-example, the RNTI can be a new RNTI, which corresponds to the use case of activating or de-activating the on-demand SSB transmission, and/or adaptation of common signals and/or channels such as SSB, PRACH, or paging.

For yet another example, the set of configurations for the DCI format can include an indication to monitor PDCCH candidates, e.g., when the configuration is provided by higher layer parameter, the UE monitors PDCCH candidates for the DCI format.
For one further evaluation, this configuration can be associated with the case that the associated search space set is a common search space (CSS) set.
For another further evaluation, the associated CSS set can be a Type3-PDCCH CSS set.

For yet another example, the set of configurations for the DCI format can include at least one indication on the starting position of a block associated with at least one serving cell or serving cell group, wherein the information bits in the DCI format can be formulated as a number of blocks indexing from 1 to N, such as “block number 1, bock number 2, . . . , block number N”, and/or each block corresponds to at least one serving cell or serving cell group.
For one further evaluation, N can be a fixed integer.
For another further evaluation, N can be provided by a higher layer parameter.
For yet another further evaluation, N can be determined based on the number of starting positions of the blocks in the set of configurations.
For yet another further evaluation, N can be determined based on a size of entries in a higher layer parameter indicating the list of serving cells or serving cell groups that support on-demand SSB.

For yet another example, the set of configurations for the DCI format can include at least one indication on the bitwidth of a block associated with at least one serving cell or serving cell group, wherein the information bits in the DCI format can be formulated as a number of blocks indexing from 1 to N, such as “block number 1, bock number 2, . . . , block number N”, and/or each block corresponds to at least one serving cell or serving cell group.
For one further evaluation, N can be a fixed integer.
For another further evaluation, N can be provided by a higher layer parameter.
For yet another further evaluation, N can be determined based on a size of entries in a higher layer parameter indicating the list of serving cells or serving cell groups that support on-demand SSB.

In one embodiment, at least one of the following example components can be included in the DCI format, or in a block within the DCI format when the information bits in the DCI format can be formulated as a number of blocks indexing from 1 to N, such as “block number 1, bock number 2, . . . , block number N”, and/or each block corresponds to at least one serving cell or serving cell group.

For one example, the at least one example component can be an indication on activation and/or deactivation of on-demand SSB transmission.
For one further evaluation, the bitwidth of the at least one example component is fixed, such as 1 bit.
For another further evaluation, the bitwidth of the at least one example component can be provided by higher layer parameter.

For another example, the at least one example component can be an indication on activation and/or deactivation of a SCell.
For one further evaluation, the bitwidth of the at least one example component is fixed, such as 1 bit.
For another further evaluation, the bitwidth of the at least one example component can be provided by higher layer parameter.
For yet another further evaluation, the indication on activation and/or deactivation of a SCell can be associated with a SCell ID or an indication of the SCell.

For another example, the at least one example component can be an indication of a cell ID of a SCell.
For one further evaluation, the bitwidth of the at least one example component is fixed, such as 10 bits.
For another further evaluation, the bitwidth of the at least one example component can be provided by higher layer parameter.

For yet another example, the at least one example component can be an indication of a time domain offset.
For one further evaluation, the bitwidth of the at least one example component is fixed, such as 1, or 2 bit.
For another further evaluation, the bitwidth of the at least one example component can be provided by higher layer parameter.
For yet another further evaluation, the unit of the offset can be a half frame.
For yet another further evaluation, the unit of the offset can be a SSB transmission burst.
For yet another further evaluation, the unit of the offset can be a slot.
For yet another further evaluation, the unit of the offset can be an OFDM symbol.
For yet another further evaluation, a UE (e.g., the UE 116) can expect the on-demand SSB transmission can occur after the time domain offset, wherein the time domain offset is with respect to the slot or half frame or symbol that includes the DCI format.
For yet another further evaluation, the at least one example component can be present in the DCI format or applicable if the on-demand SSB is indicated as activated and/or the SCell is indicated as activated.

For yet another example, the at least one example component can be an indication of a time duration.
For one further evaluation, the bitwidth of the at least one example component is fixed, such as 1, or 2, or 3 bit.
For another further evaluation, the bitwidth of the at least one example component can be provided by higher layer parameter.
For yet another further evaluation, the unit of the time duration can be a half frame.
For yet another further evaluation, the unit of the time duration can be a SSB transmission burst.
For yet another further evaluation, the unit of the time duration can be a slot.
For yet another further evaluation, the unit of the time duration can be an OFDM symbol.
For yet another further evaluation, a UE can expect the on-demand SSB transmission can occur within the time duration (potentially after the time offset if included in the DCI format).
For yet another further evaluation, if the time duration is not included in the DCI format, the UE can expect the on-demand SSB transmission can occur in a periodic manner (potentially after the time offset if included in the DCI format). For one instance, the on-demand SSB transmission can stop when indicated by the gNB. For another instance, the on-demand SSB transmission can stop when a maximum number of transmission instances or bursts is achieved, wherein the maximum number can be either fixed or provided by a higher layer parameter.
For yet another further evaluation, the at least one example component can be present in the DCI format or applicable if the on-demand SSB is indicated as activated and/or the SCell is indicated as activated.

For yet another example, the at least one example component can be an indication of a time interval or a periodicity.
For one further evaluation, the bitwidth of the at least one example component is fixed, such as 1, or 2, or 3 bit.
For another further evaluation, the bitwidth of the at least one example component can be provided by higher layer parameter.
For yet another further evaluation, the unit of the time interval or the periodicity can be a half frame.
For yet another further evaluation, the unit of the time interval or the periodicity can be a SSB transmission burst.
For yet another further evaluation, the unit of the time interval or the periodicity can be a slot.
For yet another further evaluation, the unit of the time interval or the periodicity can be an OFDM symbol.
For yet another further evaluation, the at least one example component can be present in the DCI format or applicable if the on-demand SSB is indicated as activated and/or the SCell is indicated as activated.

For yet another example, the at least one example component can be an indication of SSB transmission within a burst.
For one further evaluation, the bitwidth of the at least one example component is fixed, such as 4 bit, or 8 bit, or 16 bit, or 64 bit, potentially further subject to a subcarrier spacing (SCS) of the SSB.
For another further evaluation, the bitwidth of the at least one example component can be provided by higher layer parameter.
For yet another further evaluation, the bitwidth of the at least one example component can be equal to the actually transmitted SSB in the burst (e.g., provided by ssb-PositionsInBurst), and each bit in the bitmap corresponds to an actually transmitted SSB.
For yet another further evaluation, the indicated SSB index based on the at least one example component can be same or a subset of SSB index indicated by ssb-PositionsInBurst.
For yet another further evaluation, a UE can expect the SSB(s) indicated by the at least one example component within the same transmission burst are transmitted together (e.g., the indicated SSBs in a burst are either not transmitted or transmitted).
For yet another further evaluation, the at least one example component can be present in the DCI format or applicable if the on-demand SSB is indicated as activated and/or the SCell is indicated as activated.

For yet another example, the at least one example component can be an indication of SSB burst transmission pattern.
For one further evaluation, the bitwidth of the at least one example component is fixed.
For another further evaluation, the bitwidth of the at least one example component can be provided by higher layer parameter.
For yet another further evaluation, the bitwidth of the at least one example component can be interpreted as the number of SSB transmission bursts.
For yet another further evaluation, the first X bits in the indication (wherein the first and last bits of the X bits are Is, and the remaining bits other than the X bits in the indication are 0s) can be applicable for indicating the SSB burst transmission pattern, and X can be interpreted as the number of SSB transmission bursts.
For yet another further evaluation, each bit in the indication corresponds to a half frame or a SSB transmission burst (e.g., within a half frame), and the bit taking a value of 1 indicates that the SSB transmission burst occurs within the corresponding half frame or SSB transmission burst, and the bit taking a value of 0 indicates that the corresponding SSB transmission burst does not occur.

For yet another example, the at least one example component can be an indication on the power difference between the on-demand SSB and a reference signal.
For one further evaluation, the bitwidth of the at least one example component is fixed.
For another further evaluation, the bitwidth of the at least one example component can be provided by higher layer parameter.

For yet another example, the at least one example component can be an indication on the frequency location of the on-demand SSB.
For one further evaluation, the bitwidth of the at least one example component is fixed.
For another further evaluation, the bitwidth of the at least one example component can be provided by higher layer parameter.

In one further evaluation, at least one of the components herein in this disclosure can be included in a MAC CE. For one instance, when the at least one of the components herein is included in a MAC CE and a DCI format at the same time, a UE expects the value in the DCI format overrides the value in the MAC CE, e.g., when the UE receives the DCI format later than or no earlier than the MAC CE.

In another further evaluation, at least one of the components herein in this disclosure can be included in RRC parameters. For one instance, when the at least one of the components herein is included in RRC parameters and a DCI format at the same time, a UE expects the value in the DCI format overrides the value in the RRC parameters, e.g., when the UE receives the DCI format later than or no earlier than the RRC parameters.

In yet another further evaluation, at least one of the components herein in this disclosure can be fixed in the specification. For one instance, the UE can expect the fixed value in the specification is a default value, if the UE is not provided with another value of the at least one of the components herein from a DCI format, a MAC CE, or a RRC parameter. For another instance, the UE can expect the fixed value in the specification is override by another value, if the UE is provided with the other value of the at least one of the components herein from a DCI format, a MAC CE, or a RRC parameter.

In one embodiment, the DCI format for activating and/or deactivating the on-demand SSB transmission can be related to other DCI format.

For one example, the DCI format can be same as an existing DCI format, e.g., the at least one component in this disclosure is added to the existing DCI format by using reserved bits or unused bits.
For one instance, the existing DCI format can be DCI format 2_0.
For another instance, the existing DCI format can be DCI format 2_6.
For another instance, the existing DCI format can be DCI format 2_7.
For another instance, the existing DCI format can be DCI format 2_9.
For one further evaluation, the existing DCI format can be monitored in the search space set in the same serving cell.

For another example, the payload size of the DCI format can be same as a payload size of an existing DCI format, e.g., using the same higher layer parameter to indicate the payload size of the DCI format, or using different higher layer parameters to indicate the payload size of the DCI format but expecting the two higher layer parameters provide the same value.
For one instance, the existing DCI format can be DCI format 2_0.
For another instance, the existing DCI format can be DCI format 2_6.
For another instance, the existing DCI format can be DCI format 2_7.
For another instance, the existing DCI format can be DCI format 2_9.
For one further evaluation, the existing DCI format can be monitored in the search space set in the same serving cell.

For yet another example, the number of information bits of the DCI format can be same as a number of information bits of an existing DCI format.
For one instance, the existing DCI format can be DCI format 2_0.
For another instance, the existing DCI format can be DCI format 2_6.
For another instance, the existing DCI format can be DCI format 2_7.
For another instance, the existing DCI format can be DCI format 2_9.
For one further evaluation, the existing DCI format can be monitored in the search space set in the same serving cell.

For yet another example, the search space set to monitor the PDCCH that carries the DCI format is same as the search space set to monitor another PDCCH that carries an existing DCI format.
For one instance, the existing DCI format can be DCI format 2_0.
For another instance, the existing DCI format can be DCI format 2_6.
For another instance, the existing DCI format can be DCI format 2_7.
For another instance, the existing DCI format can be DCI format 2_9.
For one further evaluation, the existing DCI format can be monitored in the search space set in the same serving cell.

For yet another example, the number of information bits of the DCI format can be equal to or less than the payload size of an existing DCI format.
For one instance, the existing DCI format can be DCI format 2_0.
For another instance, the existing DCI format can be DCI format 2_6.
For another instance, the existing DCI format can be DCI format 2_7.
For another instance, the existing DCI format can be DCI format 2_9.
For another instance, the existing DCI format can be DCI format 1_0.
For one further evaluation, the existing DCI format can be monitored in the search space set in the same serving cell.
For another further evaluation, if the number of information bits of the DCI format is less than the payload size of an existing DCI format, zeros can be appended to the DCI format until the payload size equals to that of the existing DCI format.

In one embodiment, an example UE procedure 1300 for using the DCI format(s) to activate and/or deactivate the on-demand SSB transmission is shown in FIG. 13. In this example procedure 1300, a UE receives a first DCI format (1301). The UE determines on-demand SSB transmission is activated based on the first DCI format (1302). The UE determines resources for on-demand SSB transmission based on the first DCI format (1303). The UE receives the on-demand SSB (1304). The UE receives a second DCI format (1305). The UE determines on-demand SSB transmission is deactivated based on the second DCI format (1306).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters including a first set of configurations for a secondary cell (SCell); and
a processor operably coupled to the transceiver, the processor configured to identify, based on the set of higher layer parameters, a second set of configurations related to on-demand synchronization signals and physical broadcast channel (SS/PBCH) blocks on the SCell, wherein the second set of configurations includes a first indication of whether a transmission of the on-demand SS/PBCH blocks is activated on the SCell,
wherein the transceiver is further configured to, when the transmission of the on-demand SS/PBCH blocks is indicated to be activated based on the first indication, receive the on-demand SS/PBCH blocks based on the second set of configurations.

2. The UE of claim 1, wherein:
the transceiver is further configured to receive a first medium access control (MAC) control element (CE) including a second indication of whether the transmission of the on-demand SS/PBCH blocks is activated on the SCell; and
the reception of the on-demand SS/PBCH blocks is based on the second indication.

3. The UE of claim 2, wherein:
the transceiver is further configured to receive a second MAC CE including an indication that the SCell is activated, and
the first MAC CE is received in a previous slot to or a same slot as the second MAC CE.

4. The UE of claim 1, wherein the second set of configurations include time, frequency, power, and spatial domain information for the on-demand SS/PBCH blocks.

5. The UE of claim 4, wherein:
the time domain information includes multiple candidate sets of configurations, and
a first medium access control (MAC) control element (CE) indicates one set from the multiple candidate sets of configurations to be activated.

6. The UE of claim 1, wherein the processor is further configured to perform layer 1 measurement or radio resource management (RRM) measurement based on the on-demand SS/PBCH block.

7. The UE of claim 1, wherein the processor is further configured to identify, based on the set of higher layer parameters, a third set of configurations for periodic SS/PBCH blocks on the SCell.

8. A base station (BS) in a wireless communication system, the BS comprising:
a processor configured to:
determine a first set of configurations for a secondary cell (SCell); and
determine a second set of configurations related to on-demand synchronization signals and physical broadcast channel (SS/PBCH) blocks on the SCell, wherein the second set of configurations include a first indication of whether a transmission of the on-demand SS/PBCH blocks is activated on the SCell; and
a transceiver operably coupled to the processor, the transceiver configured to:
transmit a set of higher layer parameters including the first set and the second set of configurations; and
transmit the on-demand SS/PBCH blocks based on the second set of configurations, when the transmission of the on-demand SS/PBCH blocks is indicated to be activated based on the first indication.

9. The BS of claim 8, wherein:
the transceiver is further configured to transmit a first medium access control (MAC) control element (CE) including a second indication of whether the transmission of the on-demand SS/PBCH blocks is activated on the SCell; and
the transmission of the on-demand SS/PBCH blocks is based on the second indication.

10. The BS of claim 9, wherein:
the transceiver is further configured to transmit a second MAC CE including an indication that the SCell is activated, and
the first MAC CE is transmitted in a previous slot to or a same slot as the second MAC CE.

11. The BS of claim 8, wherein the second set of configurations include time, frequency, power, and spatial domain information for the on-demand SS/PBCH blocks.

12. The BS of claim 11, wherein:
the time domain information includes multiple candidate sets of configurations, and
a first medium access control (MAC) control element (CE) indicates one set from the multiple candidate sets of configurations to be activated.

13. The BS of claim 8, wherein the processor is further configured to determine a third set of configurations for periodic SS/PBCH blocks on the SCell.

14. A method of a user equipment (UE) in a wireless communication system, the method comprising:
receiving a set of higher layer parameters including a first set of configurations for a secondary cell (SCell);
identifying, based on the set of higher layer parameters, a second set of configurations related to on-demand synchronization signals and physical broadcast channel (SS/PBCH) blocks on the SCell, wherein the second set of configurations includes a first indication of whether a transmission of the on-demand SS/PBCH blocks is activated on the SCell; and
when the transmission of the on-demand SS/PBCH blocks is indicated to be activated based on the first indication, receiving the on-demand SS/PBCH blocks based on the second set of configurations.

15. The method of claim 14 further comprising:
receiving a first medium access control (MAC) control element (CE) including a second indication of whether the transmission of the on-demand SS/PBCH blocks is activated on the SCell; and
the reception of the on-demand SS/PBCH blocks is based on the second indication.

16. The method of claim 15 further comprising:
receiving a second MAC CE including an indication that the SCell is activated, and
the first MAC CE is received in a previous slot to or a same slot as the second MAC CE.

17. The method of claim 14, wherein the second set of configurations include time, frequency, power, and spatial domain information for the on-demand SS/PBCH blocks.

18. The method of claim 17, wherein:
the time domain information includes multiple candidate sets of configurations, and
a first medium access control (MAC) control element (CE) indicates one set from the multiple candidate sets of configurations to be activated.

19. The method of claim 14 further comprising performing layer 1 measurement or radio resource management (RRM) measurement based on the on-demand SS/PBCH block.

20. The method of claim 14 further comprising identifying, based on the set of higher layer parameters, a third set of configurations for periodic SS/PBCH blocks on the SCell.
